(19) United States
(12) Patent Application Publication
(10) Pub. No.: US 2010/0301077 A1
(43) Pub. Date: Dec. 2, 2010

(54) BEVERAGE CONTAINER CARRIER

(75) Inventors: Colin Robertson, Brighton (AU); Michael Rule, Bentleigh East (AU)

Correspondence Address: HARNESS, DICKEY & PIERCE, P.L.C., P.O. BOX 828, BLOOMFIELD HILLS, MI, 48303, US

(73) Assignee: POPART AUSTRALIA PTY LTD, Cheltenham, Victoria (AU)

(21) Appl. No.: 12/677,826

(22) PCT Filed: Sep. 11, 2008
(86) PCT No.: PCT/AU2008/001360

§ 371 Date: Mar. 12, 2010

(30) Foreign Application Priority Data
Sep. 12, 2007 (AU) 2007904962

(51) Int. Cl. A45F 5/00; B42D 15/00

(52) U.S. Cl. 224/148.4; 283/56

(57) ABSTRACT

A carrier for carrying one or more beverage containers of the kind having a base and a wall extending from the base, the base and wall defining an interior beverage containing space, each beverage container further including an opening opposite the base which is circumscribed by a rim and a protrusion extending laterally relative to the wall near to or at the rim. The carrier includes a support body including at least one opening; and a handle extending from the support body. In use, a beverage container is received within at least one of the openings and is releasably supported therein through the cooperative engagement of a surface associated with an edge of the opening. The present invention functions as a carrier for carrying one or more beverage containers and can be used as part of an advertising arrangement.

### FIELD OF THE INVENTION

The present invention generally relates to a carrier for carrying one or more beverage containers and an advertising arrangement including the carrier. The invention is particularly applicable as a carrier for one or more beverage containers of the kind used to serve soft drinks and alcoholic beverages at functions and events and it will be convenient to hereinafter disclose the invention in relation to that exemplary application. However, it is to be appreciated that the invention is not limited to that application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Beverages such as soft drinks and alcoholic beverages are served in beverage containers, such as plastic cups, in certain commercial locations. A consumer can typically comfortably carry up to three plastic cups in their hands. However, when the consumer orders two or more beverages, they will usually require a carrier in which the cups can be supported to more easily transport the cups from one location (say for example a bar area) to another location (say for example seating where their friends are situated).

A large number of carriers are currently available. The most common carrier used for plastic cups comprises a cardboard or recycled paper tray which includes two or more depressions or other cooperative recesses designed to receive and support each base of the plastic cups. A consumer can place the cups in the tray and then carry the tray with the cups supported thereon from a bar area back to their seats.

However, it can be difficult to keep a cup filled with a beverage steady in this type of tray arrangement that supports the cups at their base. In this respect, while the base is firmly secured relative to the tray, the upper part of a cup is able to move relative to the tray. Therefore, when a consumer transports one or more cups supported in the tray, movement of the tray can cause beverage to be spilt from the cups through movement of the upper mouth part of the cup relative to the tray. This can be exacerbated when transporting the tray in a limited space, say for example a crowded room.

It would therefore be desirable to provide an alternate beverage carrier.

### SUMMARY OF THE INVENTION

According to the present invention, there is provided a carrier for carrying one or more beverage containers of the kind having a base and a wall extending from the base, the base and wall defining an interior beverage containing space, each beverage container further including an opening opposite the base which is circumscribed by a rim and a protrusion extending laterally relative to the wall near to or at the rim, the carrier including:
a support body including at least one opening; and
a handle extending from the support body,
wherein, in use, a beverage container is received within at least one of the openings and is releasably supported therein through the cooperative engagement of a surface associated with an edge of the opening and a portion of the wall and/or protrusion of the beverage container.

The carrier of the present invention can be used with a variety of beverage containers of a various range of sizes. It is contemplated that the carrier could be configured to accommodate beverage containers ranging from large “bucket” sized vessels through to small “thimble” sized containers. The carrier of the present invention is intended to fit beverage containers of differing configurations. For example, some beverage containers have a diameter that tapers from a maximum diameter at the opening and/or rim of the cup to a minimum diameter at the base of the beverage container. This type of beverage container can be wedged into cooperative engagement with a surface associated with an edge of the opening or supported from a portion of the protrusion of the beverage container. For example, the opening can have a diameter which is smaller than the maximum diameter of the beverage containers. Here, a tapered type of beverage container would be received within the opening and become wedged therein at some point between the base and the rim of the cup. It is preferred for the cup to be supported in the opening at a point between 2 to 40 mm, preferably 10 to 30 mm axially away from the protrusion on the wall of the cup.

In other embodiments, a beverage container can be received within at least one of the openings and be releasably supported therein through the cooperative engagement of a surface associated with an edge of the opening and the protrusion of the beverage container. This arrangement supports a beverage container, such as for example a plastic cup, at or near to the rim section of the beverage container. This provides a more stable support for the beverage container within the carrier (as compared to cup base support type carriers) because the upper portion of the beverage container is seated on a surface associated with the edge of the opening and is therefore substantially restrained from movement relative to the carrier when in use. Less of the beverage is therefore likely to be lost when transporting the beverage container in the carrier.

The surface associated with an edge of the opening can be located at the edge of an opening or at a surface which is substantially annularly aligned with the edge of the openings. For example, in some embodiments, a beverage container is received within at least one of the openings and is releasably supported therein through the cooperative engagement of an edge of the opening and the protrusion of the beverage container. In other embodiments each opening can include at least two axially extending fingers spaced apart around the edge of each opening. A beverage container can be releasably supported within the opening through the cooperative engagement of an edge of each of the fingers and a portion of the wall and/or protrusion of the beverage container. While two axially extending fingers could be configured to adequately support a beverage container within the opening, it is preferable for each opening to include four axially extending fingers spaced substantially evenly apart around the edge of each opening.

Where the fingers are used to cooperatively engage with a wall portion of the cup, it is preferred for the cup to be supported on the fingers at a point between 2 to 40 mm, preferably 10 to 30 mm axially away from the protrusion on the wall of the cup. Again, this supports a beverage container at or near to the rim section of the beverage container providing a more stable support for the beverage container within the carrier as compared to cup base support type carriers.

Where the carrier is of the kind in which the protrusion includes a substantially annular groove proximate an interface between the wall and the protrusion, a beverage container can be releasably supported within an opening of the carrier through the cooperative engagement of an edge of the finger(s) within the annular groove of the protrusion of the beverage container.

The axially extending fingers are preferably flexible. The axially extending fingers also preferably extend away from the edge of the opening at an angle towards the center of the opening. The flexible nature and angled configuration allows the fingers to engage with beverage containers having a variety of diameters. Preferably, the fingers can accommodate beverage containers which differ in diameter of between 5 to 30%, and preferable between 10 to 15%. For example, in one form this would allow the carrier to accommodate beverage containers which fit the volume of between 425 to 500 mL of liquid. In another form this would allow a single carrier to accommodate beverages provided in small, medium and large sized take away beverage cups such as disposable paper coffee cups.

In order to stably support a number of beverage containers within the carrier, it is preferable for the handle to be centrally located on the support body. Generally, this would result in the handle being generally located at the geometric center of the support body. However, when the support body includes two or more openings it is preferable for the handle to be generally centrally located with respect each of the two or more openings.

The support body can have any suitable configuration such as (but not limited to) a spherical configuration or a generally planar configuration. In planar embodiments, the support body can have a generally circular shape, square shape, or the like. However in most embodiments the support body includes a generally planar support surface through which each of the openings extend. Typically, the handle extends generally perpendicular to the support surface. It is also preferred for the handle to be generally centrally located on the support surface, preferably at the geometric center of the support surface.

The openings can have any configuration suitable for receiving the beverage containers. Preferably, the openings have a generally similar shape to the shape of the wall of the beverage container to securely receive the beverage container within the opening and maintain substantially full contact between the container wall and the edge of the opening. For example, a square shaped opening would be used to receive a beverage container having a square shaped wall and a circular opening would be used to receive a beverage container having a circular shaped wall. The shape of the at least one opening can have a complementary shape to the maximum diameter of the beverage container. Of course, the opening does not have to completely surround the wall of the beverage container. In some embodiments, the opening could have an arcuate shape, say for example a half circle opening or ¾ circle opening, which provides a gap.

The carrier and more particularly the openings of the carrier can be configured to receive various sizes of beverage containers. In some forms, the opening preferably allows for variances in the diameter of a beverage containers held therein. Preferably, the openings of the carrier can accommodate changes of between 10 to 15% in the diameter of the beverage container. In other forms, the opening can include flexible engagement features such as flexible fingers to accommodate various sizes of beverage containers.

The handle can have any suitable configuration which extends away from the support body. In some embodiments, the handle is formed using a simple flexible member such as a strip of flexible material, rope, wire or the like. In other embodiments, the handle is formed from a more rigid arrangement, such as an elongate body which extends vertically from the support surface. In each form, it is preferred for the handle to include a finger grip portion which allows a user to hold the carrier in one hand or their fingers. The finger grip portion is preferably spaced from the support surface and is generally centrally located with respect to each of the openings. Preferably, the finger grip portion is configured to allow a user to manually grasp and hold the handle with two or more fingers.

In one exemplary form, the handle includes one or more elongate struts which are connected to and extend away from the support surface. In some arrangements, the handle can also include a mounting structure at a free end of the struts, such as a recess, into which a further device or body, for example an advertising or promotion disc, can be releasably received. Preferably, the recess includes one or more tabs or protrusions which can be used to secure the promotion disc into position. More preferably, the tabs engage an upper surface of the promotion disc when received in the recess to releasable secure the promotion disc into the handle.

In one particular embodiment of the carrier, the handle includes a handle mount and the finger grip portion. In some forms, the finger grip portion is separate component to the handle mount, and includes one or more cooperating arrangements that allow the finger grip portion to be releasably secured to the handle mount when required. In other embodiments, the finger grip portion is integrally formed with the handle mount.

It should be appreciated that in a commercial situation, such as for example a bar or function centre, a plurality of these carriers will be used. It is therefore advantageous to be able to store and transport as many of the carriers according to the present invention as possible in the minimum amount of space. Generally, this would require each of the carriers to be able to be easily stacked on top of each other, and more preferably to have features which allow parts of the carrier to nest into an adjacent carrier in the stack. This nesting feature can be achieved by configuring the handle to nest with at least an upper portion of the handle of a second carrier. Preferably, the handle has a frustoconical configuration and is substantially hollow to provide this nesting feature.

In order to remove a beverage container from the support body, a user will typically grasp the side or rim of the container and pull the container out of the at least one opening. It is therefore preferable to include one or more removal assist arrangements to help a user extract the beverage container from at least one of the at least one openings of the support body. Many different removal assist arrangements could be used, including tabs attached to the beverage containers, leverage means, lifting devices or the like. In a preferred arrangement, at least one finger recess is provided in or adjacent to one or more openings of the support body. These finger recesses allow a user's fingers, to engage a portion of a beverage container supported in an opening at a location at or below the rim.

The finger recesses can have various configurations. In one configuration, the recesses form dimples or scallop shaped depressions in the support body. In another configuration, the finger recesses form an opening which extends through the support body and which preferably opens into a support body opening. While it is possible to have any number of finger recesses, it is preferred for each opening to include two or more finger recesses spaced apart around the edge of the at least one opening. More preferably, at least two finger recesses are located at diametrically opposed positions about the edge of the at least one opening. This configuration allows a user to use their thumb and an opposing finger (such as for example their forefinger) to grip opposite sides of the beverage container via the finger recesses and then extract the beverage container from the opening.

In the protrusion support embodiment, the carrier can be used to carry any type of beverage container which includes a protrusion at or near the rim of the container. The protrusion can be any suitable feature which can cooperatively engage an edge of the at least one opening in the support body such as a ledge, flange, projections, ridge, embossment, shoulder, lip or the like. However, in most beverage containers used to serve soft drink and alcoholic beverages at functions, the protrusion is preferably configured as a annular portion or portions which in use enables the beverage container to be seated on a substantial portion of a surface associated with the edge of the opening. Most typically, the protrusion is an annular flange or bead.

According to another aspect of the present invention, the carrier is used as an advertising or promotional medium. In this respect, one or more surfaces of the carrier can include an advertising or promotion such as a printed, painted, formed, embossed or the like advertisement. Where the carrier includes a support surface, it is preferred that the support surface includes the advertising or promotion. As can be appreciated, the advertising or promotion can be integrally formed with the support surface. For example, the advertisements could be directly printed on the support surface. Alternatively, a separate advertising or promotion could be seated or otherwise supported on the support surface.

In one preferred embodiment of the present invention, a carrier according to the present invention further includes an advertising or promotion substrate (herein after referred to as an “advertising substrate”) which can be releasably supported on the support body. In order to allow the carrier to receive beverage containers through the openings of the support body and function normally, the advertising substrate can include one or more openings for the handle and the at least one opening of the support body. As can be appreciated, the openings of the advertising substrate could have any suitable configuration. Although, it would of course be preferred for the openings to have a configuration which did not substantially impede the support function of the support body or impede the beverage containers from being received in at least one of the at least one openings of the support body. This could entail the openings in the advertising substrate simply being larger than the openings in the support body. Therefore, the openings in the advertising could have any shape and still not impede the support function of the support body or impede the beverage containers from being received in at least one of the at least one openings of the support body. However, it is more preferable for the one or more openings of the advertising substrate to include at least one complementary opening for the at least one openings of the support body. The shape of the opening of the advertising substrate is therefore substantially similar to the shape of the openings of the support body.

Many different forms of advertising substrates can be supported on the support body. For example, the advertising substrate could comprise one or more sections of printed paper which are adhered to the support body using an adhesive. In another embodiment, the advertising substrate comprises a shaped figure or body which is releasably secured to the support body through a peg being received in a corresponding hole. Preferably, the advertising substrate comprises a sheet having a printed surface configured to be seated on the support body. In this particular embodiment, one or more openings of the advertising substrate preferably include an edge configured to engage a portion of the support body or handle to releasably retain the substrate in position relative to the support body and the at least one opening of the support body. The support body can also include one or more ridges configured to engage an edge of the advertising substrate and locate the advertising substrate in position relative to the support body and the at least one opening of the support body. Similarly, one or more of the cooperating openings of the advertising substrate can include a handle aperture through which the handle extends, the handle aperture including at least one edge portion which abuts and engages a portion of the handle.

According to yet another aspect of the present invention, there is provided an advertising arrangement including:
a carrier for carrying one or more beverage containers of the kind having a base and a wall extending from the base, the base and wall defining an interior beverage containing space, each beverage container further including an opening opposite the base which is circumscribed by a rim and a protrusion extending laterally relative to the wall near to or at the rim, the carrier including a support body including at least one opening, and a handle extending from the support body; and
an advertising substrate which can be releasably supported on the support body, the advertising substrate having one or more openings for the handle and the at least one opening of the support body,
wherein, in use, a beverage container is received within at least one of the openings and is releasably supported therein through the cooperative engagement of a surface associated with an edge of the opening and/or the advertising substrate supported thereon and a portion of the wall or protrusion of the beverage container.

The advertising arrangement can further include a promotion disc which can be releasably secured within the handle of the carrier.

The carrier can be manufactured from a variety of material including metals, such as for example aluminium, paper based products such as cardboard, plastics such as for example polyethylene terephthalate (PET), Poly(vinyl chloride) (PVC), or High Impact Polystyrene (HIPS), virgin or recycled polypropylene or a biopolymer such as for example polylactic acid (PLA). Preferably, the carrier is manufactured using a degradable material, preferably biodegradable material. One suitable material is a biopolymer based on high amylose corn-starch.

Similarly, the advertising substrate can be manufactured from any suitable material, including paper, cardboard, plastics, metal or the like. In one preferred embodiment, the advertising substrate is manufactured from cardboard.

It should also be appreciated that the carrier is configured to carry beverage container manufactured from a range of materials including plastic, foam, glass, paper, ceramic, wood, metal or the like. The beverage containers could be carried with or without a safety lid.

### BRIEF DESCRIPTION OF THE DRAWINGS

The present invention will now be described with reference to the figures of the accompanying drawings, which illustrate particular preferred embodiments of the present invention, wherein:

FIG. 1 is perspective view of a first embodiment of the carrier according to the present invention.

FIG. 2 is a perspective view taken from the underside of the carrier shown in FIG. 1.

FIG. 3 is a perspective view of the carrier shown in FIG. 1 with an advertising sheet mounted thereon.

FIG. 4 is an exploded view of the carrier shown in FIG. 3.

FIG. 5 is perspective view of a second embodiment of the carrier according to the present invention.

FIG. 6 is perspective view of the carrier shown in FIG. 5 with cups support therein.

FIG. 7 is perspective view of a second preferred embodiment of the carrier according to the present invention.

FIG. 8 is a perspective view taken from the underside of the carrier shown in FIG. 7.

FIG. 9 is perspective view of the carrier shown in FIG. 7 with cups support therein.

### DETAILED DESCRIPTION

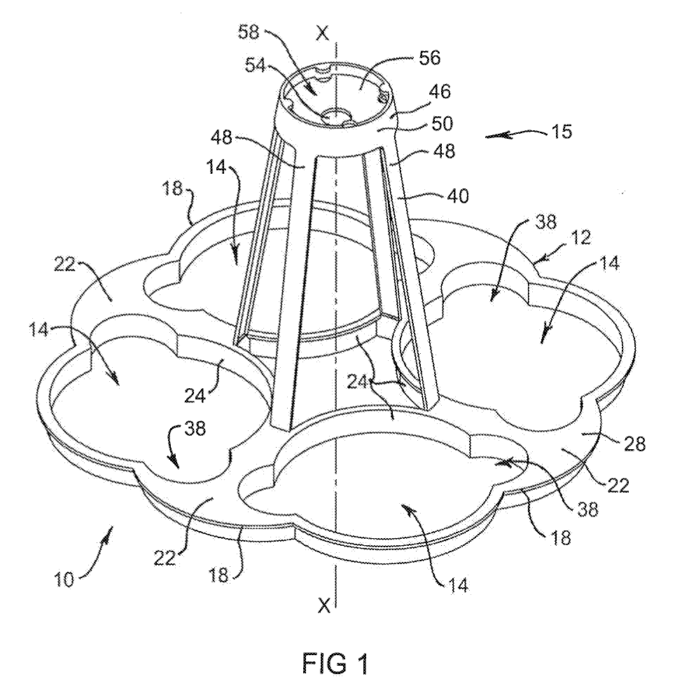

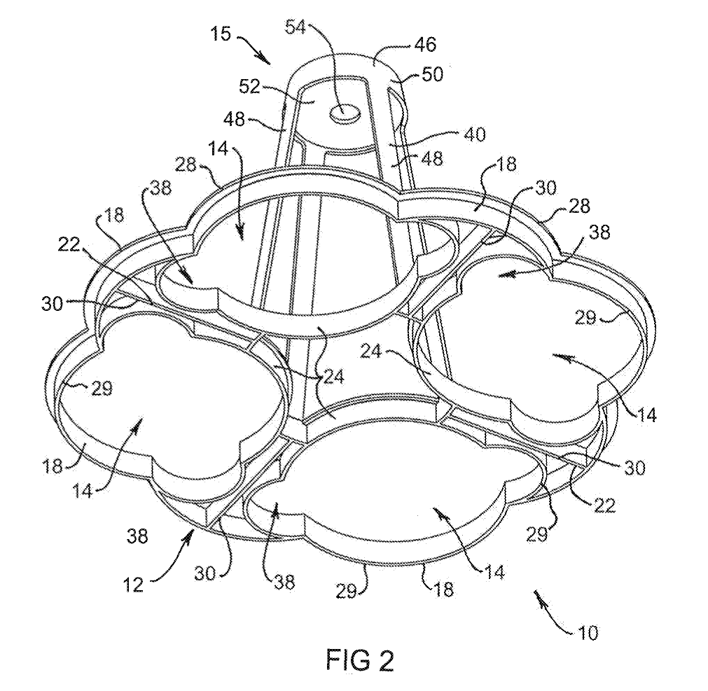

Referring firstly to FIGS. 1 and 2, there is illustrated a plastic carrier 10 for beverage receptacles according to one preferred form of the present invention. The illustrated carrier 10 is formed of moulded polymer, preferably a biodegradable polymer such as a biopolymer based on high amylose corn-starch. However, it should be appreciated that other polymers such as petroleum based plastics or other materials, for example a metal, could also be used without affecting the overall function of the carrier 10.

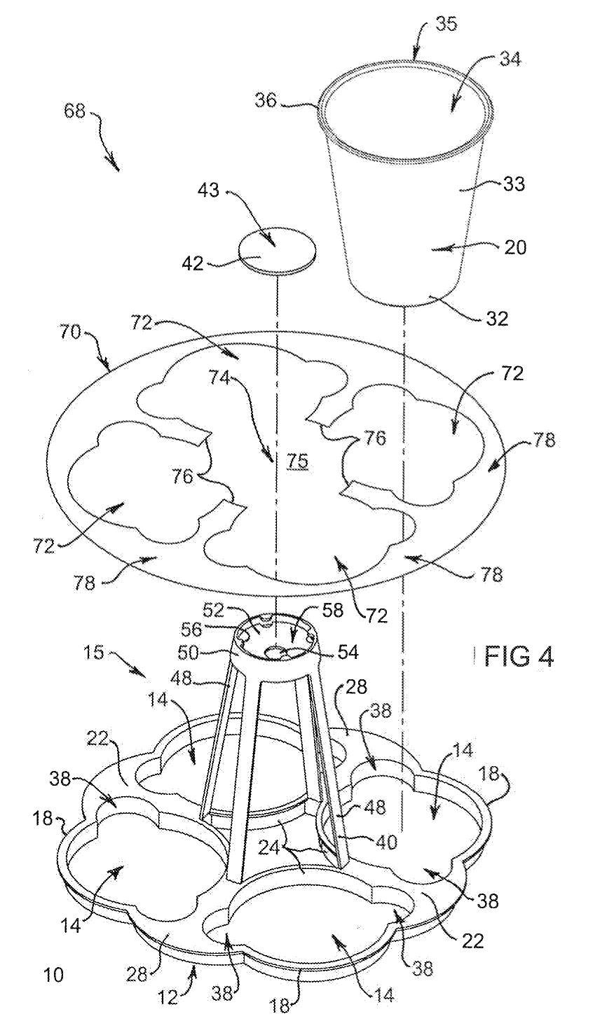

The illustrated carrier 10 is configured to carry at maximum four beverage receptacles. In this respect, the carrier 10 includes a planar support structure 12 which includes four generally circular openings 14 through which a beverage container, like for example the plastic cup 20 (shown in FIG. 4) can be received. Each of the four openings 14 extends through the support structure 12 and is evenly spaced around a common geometric central axis X-X. A handle 15 extends perpendicularly from the support structure 12 through and about the central axis X-X. The handle 15 is intended to allow a user to carry the carrier 10 about the central axis X-X.

The support structure 12 is configured to receive and support beverage containers therein. As best shown in FIG. 2 (where the carrier 10 is shown upturned) the support structure 12 is formed from an integrally moulded framework of cross-members 18, 22, 24 arranged to form and reinforce the generally circular shape of the openings 14. In this respect, the support structure 12 generally includes an outer ring of perimeter members 18, and an inner ring of inner members 24 which are generally laterally (and integrally) interconnected by lateral members 22. As shown in FIG. 2, each of the perimeter members 18, inner members 24 and lateral members 24 include laterally orientated rib members 26 which are connected to an upper planar support surface 28. Each opening 14 is framed by a perimeter rib 29 which strengthens the edge of each opening 14. Similarly, a strengthening rib 30 is located between each opening 14 as part of each lateral member 22 to strengthen the structure between each of the openings 14.

Each opening 14 is configured to receive a beverage container having a generally circular cross-section, like for example the plastic cup 20 shown in FIG. 4. Referring to FIG. 4, this particular plastic cup 20 includes a circular base 32 and an endless wall 33 extending from the base 32. As can be appreciated, a beverage such as a soft drink, alcoholic beverage or similar can be poured into the internal space between the base 32 and wall 33. The plastic cup 20 includes an opening 34 opposite the base 32 through which the beverage is received and drunk. The opening 34 is circumscribed by a rim 35. The rim 35 includes an annular bead 36 which extends laterally relative to the wall at the rim 35. In use, the cup 32 is received in one of the openings 14 and is supported by the carrier 10 through a cooperative engagement of the bead 36 of the cup 20 and the section of the support surface 28 around the edge of the opening 14.

Each opening 14 is designed to allow for small variances in the tolerances of a particular sized beverage cup 20. For example, for a 425 mL cup, the carrier 10 can accommodate ±2 to 3 mm changes in the diameter of the rim 35 of the cup 20.

Each opening 14 also includes two diametrically opposed finger recesses 38 located at opposite sides of the opening 14. The illustrated finger recesses 38 comprise half circle openings located in the sides of the openings 14. The finger recesses 38 help a user grip a beverage container that is located within an opening 14. When a beverage container, such as for example cup 20 (shown in FIG. 4) is received in an opening 14, the cup 20 extends through the opening 14, with only the rim 35 and bead 36 extending above the support surface 28. The finger recesses 38 enable a user to place at least one finger, and preferably a thumb and finger into the finger recess 38 and grip the side 33 and/or rim 35 of a cup 20. It should be appreciated that the finger recesses 38 do not necessarily need to be through holes, and in other embodiments could be grooves, trenches, depressions or the like having a depth which allows a users fingers to engage the side 33 and/or rim 35 of a cup 20, for example the cup 20 shown in FIG. 4.

Still referring to FIG. 1, it can be seen that the handle 15 is formed as a generally frustoconical shaped handle mount 40. Some embodiments can also include a mushroom shaped finger grip (not illustrated).

The illustrated handle mount 40 includes an upper circular hub 46 connected to the support surface 28 through four laterally inclined rectangular struts 48. Each of the struts 48 is spaced apart around the central axis X-X to form a general frustoconical shape. The upper hub 46 includes an upper cone shaped wall 50 in which a circular top plate 52 is located in a disc recess 58. The top plate 52 includes a central through-hole 54 (best seen in FIG. 4) through and into which a users finger can be inserted from below. In use, a user can grip the handle 15 to carry the carrier 10 by inserting their fingers in the gaps between the struts 48 and engage the walls 50. In the illustrated embodiment, the shape of the handle 15 provides a balance point where three cups can be carried in a generally balanced arrangement. When three cups are carrier, the wall 50 is engaged by a users fingers in the side of the hub 46 at the middle of the three cups so as to balance the mass distribution of the overall arrangement.

In some embodiments, the handle 14 can further include a finger grip (not illustrated). This finger grip can have a mushroom configuration having a fastening stem which includes fastening protrusions which allow the fastening stem to be snap fitted into a through-hole, for example through-hole 54. In use, a user can grip the finger grip between two fingers and carry the carrier 10 in their hand.

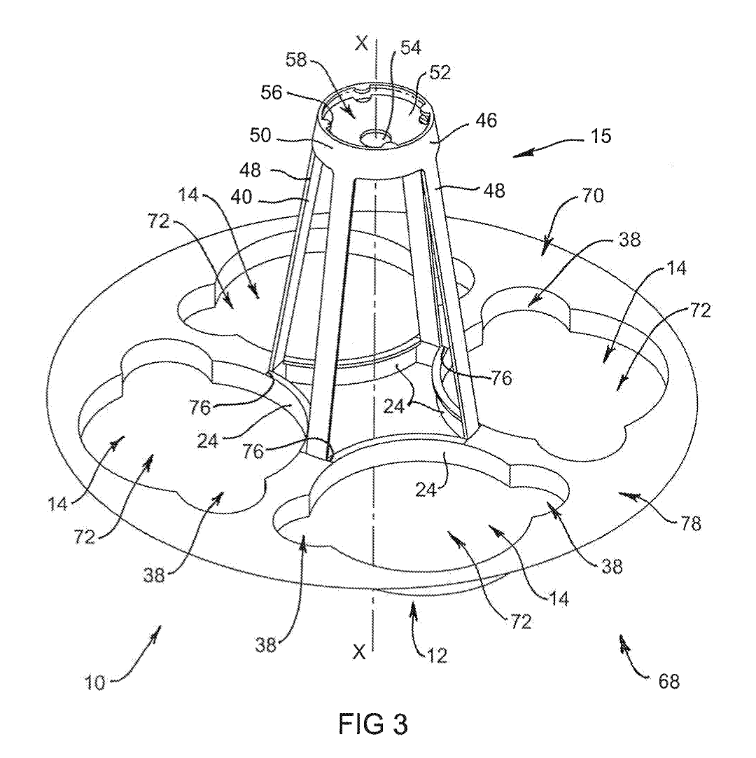

The carrier 10 for beverage receptacles of FIGS. 1 and 2 is shown configured into an advertising arrangement 68 in FIGS. 3 and 4. The advertising arrangement 68 uses the same carrier 10 with the inclusion of a cardboard advertising sheet 70 supported on the support surface 28 of the support structure 12 and a cardboard top promotion disc 42 (shown in FIG. 4) which can be inserted into disc recess 58 in the upper hub 46 of the handle mount 40. It should be appreciated that the advertising sheet 70 could be formed of other materials in other embodiments.

As shown in FIG. 4, the promotion disc 42 is essentially a circular disc shaped to fit into the disc recess 58 in the upper hub 46 of the handle mount 40. When inserted in the recess 58, the promotion disc 42 is held in position through tabs 58 which are circumferentially spaced around the edge of the disc recess 58. Through-hole 54 is provided to allow a user to insert their finger or another shaft or device to contact the disc recess 58 from below and allow the disc to be pushed out from the disc recess 58 if and when required.

As shown in FIGS. 3 and 4, the advertising sheet 70 is essentially an irregular but generally circular shaped planar sheet, having an internal opening 74 cut out to complement the shape of the openings 14 and handle 15 of the carrier 10. The internal opening 74 includes four complementary openings 72 to openings 17 of the carrier 10 for beverage containers, such as cup 20 in FIG. 4. As shown in FIG. 3, each of the four complementary openings 72 have a similar shape to said openings 17 of the carrier 10. The internal opening 74 also includes a central opening 75 through which the handle 15 can be received.

The advertising sheet 70 includes engagement edges 76 proximate to the central opening 75 to help properly orientate and retain the advertising sheet 70 in position of the support surface 28 of the carrier 10. The engagement edges 76 are configured to abut and engage struts 48 so as to locate and/or releasably retain the substrate in position relative to the support body 12 and the openings 14 of the support body 12. However, it should be appreciated that this function could also be provided by ridges (not illustrated) or other protrusions (not illustrated) provided on or around the support surface 28 into, on or between which various sections of the advertising sheet 70 can be placed.

The promotion disc 42 and the advertising sheet 70 provide a substrate on which advertising can be presented to the user of the carrier 10. To this end, indicia, images, colours shapes or combinations thereof can be printed or otherwise placed to form an advertisement(s) on the top surface 78 of the advertising sheet 70 and the top surface 43 of the promotion disc 42. For example, in one form the top surface 78 includes a scratch off material which can be used as part of a game or competition. In other forms, the top surface 78 of the advertising sheet and/or the top surface 43 of the promotion disc 42 include indicia and images providing information for one or more products.

Referring now to FIG. 4, there is shown a construction view of the advertising arrangement 68 shown in FIG. 3. As can be observed, the carrier 10 forms the base structure for the arrangement on which all the other components are arranged. In this respect, advertising sheet 70 is seated on top of the support surface 28 of the carrier 10, with the handle 15 received through the central opening 75 and with the complementary openings 72 aligned with openings 17. Promotion disc 42 can be inserted into disc recess 58. One to four plastic cups 20 can then be received through one of the openings 14 in the support structure 12 and inserted until the annular bead 36 of the cup is seated on the support surface 28 around the edge of that opening 14 and any section of advertising sheet 70 on that section of the support surface 28.

In use, a user can transport one or more beverage cups 20 and beverage received in the openings 14 of the carrier 10 and/or advertising arrangement 68 through gripping the finger grip section 42. As can be appreciated, the central position of the finger grip section 42 and handle 15 provides a stable position to carry the beverage containers. When four beverage cups 20 are supported in the carrier 10, the handle 15 and finger grip 42 are positioned generally at the centre of mass of the combined arrangement (which would be generally along axis X-X), thereby providing a stable platform from which to transport the beverage cups 20 and beverages contained therein.

The carriers 10 can also be nested together with a plurality of cups 20 held in each of the openings 14 to assist in the bulk transport of the carriers 10 and beverage cups 20 that fit within the carriers 10.

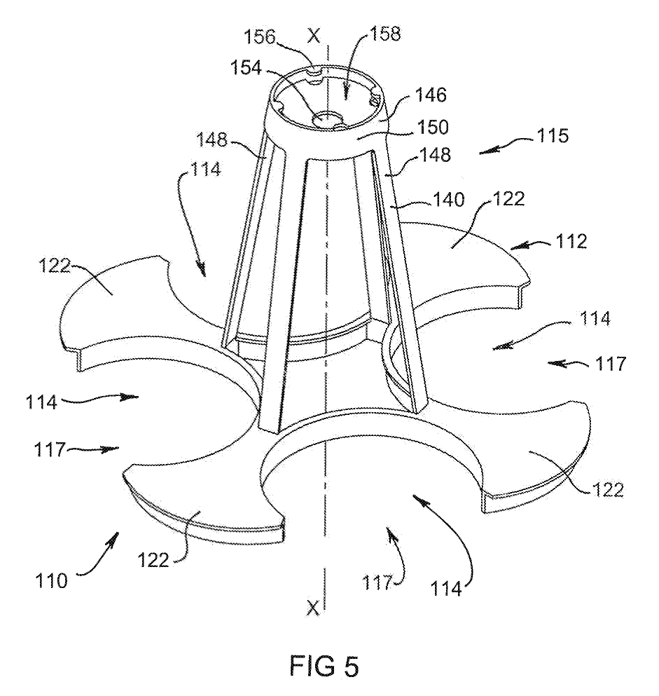

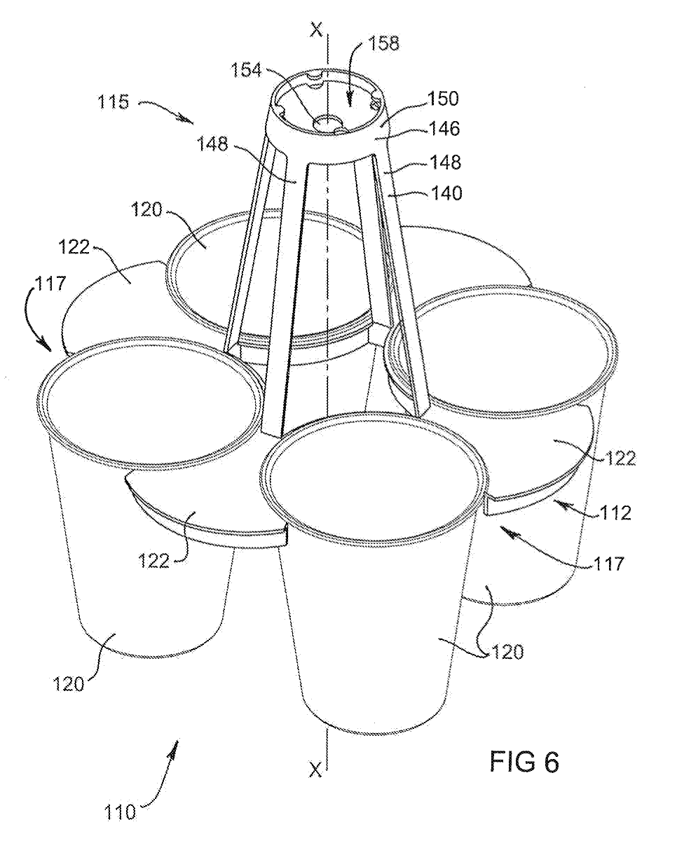

Referring now to FIGS. 5 and 6, there is shown a second embodiment of the carrier 110 according to the present invention. This embodiment of the carrier 110 has a number of similar features to the embodiment of the carrier 10 shown in FIGS. 1 to 4 and therefore the same reference numerals have been used plus 100.

Again, the illustrated carrier 110 is configured to carry at maximum four beverage receptacles. In this respect, the carrier 110 includes a planar support structure 112 which includes four openings 114 through which a beverage container, like for example the plastic cup 120 (shown in FIG. 6) can be received. Unlike the carrier 10 shown in FIGS. 1 to 4, these openings 114 are not complete through-openings in the support surface 112, but rather comprise about ¾ the circumference of a circle forming an arcuate recess in the side of the openings 114, leaving a gap 117. Again, each of the four openings 114 is evenly spaced around a common geometric central axis X-X and extends through the support structure 112. A handle 115 having a similar frustoconical configuration as the embodiment of the carrier 110 shown in FIGS. 1 to 4 is also provided. The handle 115 extends perpendicularly from the support structure 112 and is formed from a framework of struts 148 and upper hub 146.

As shown in FIG. 6, each opening 114 is configured to receive a beverage container 120 having a generally circular cross-section. No finger recesses are required to assist in the removal of the cups 120 in this embodiment due to the gap 117, which allows a user to easily grip the side of the cup 120.

Again, the carrier 110 can be used as an advertising arrangement 68 through the inclusion of a cardboard advertising sheet 70 (similar to that shown in FIG. 4) supported on the support surface 128 of the support structure 112 and a cardboard top promotion disc 42 (similar to that shown in FIG. 4) which can be inserted into disc recess 158 in the upper hub 146 of the handle mount 140.

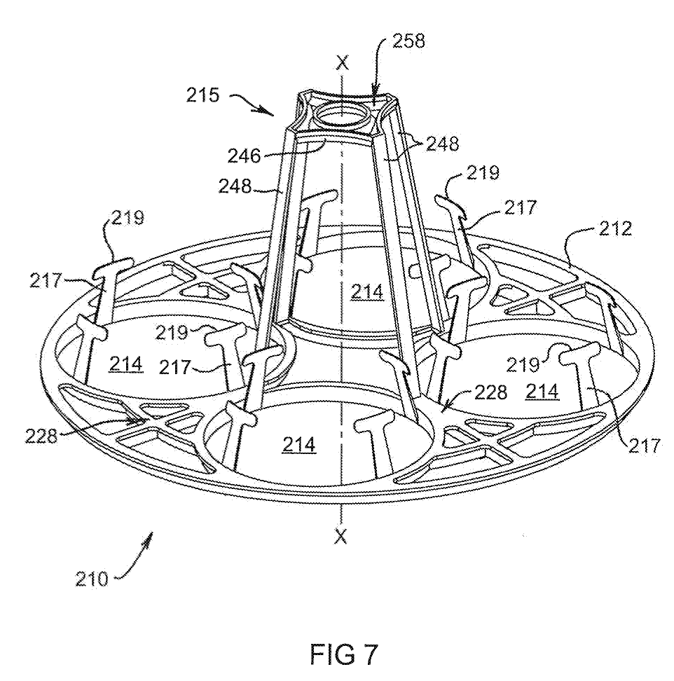

Referring now to FIGS. 7 to 9, there is shown a third embodiment of the carrier 210 according to the present invention. This embodiment of the carrier 210 has a number of similar features to the embodiment of the carrier 10 shown in FIGS. 1 to 4 and therefore the same reference numerals have been used plus 200.

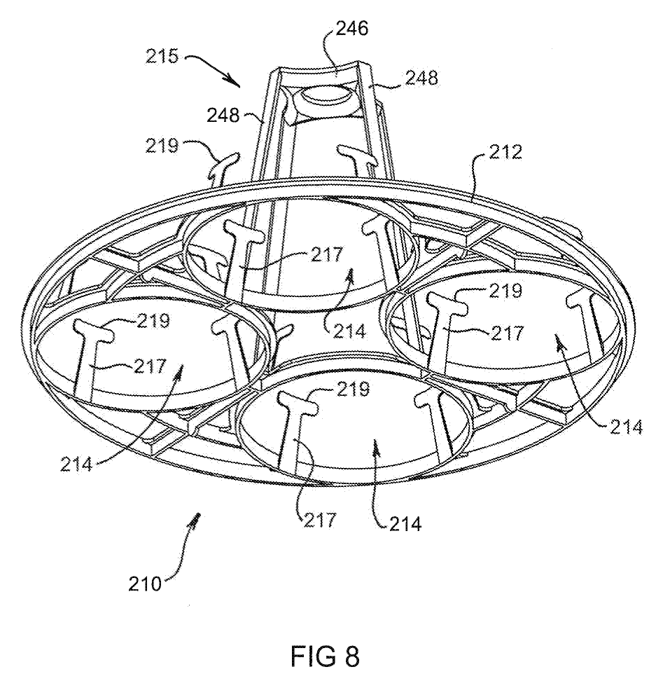

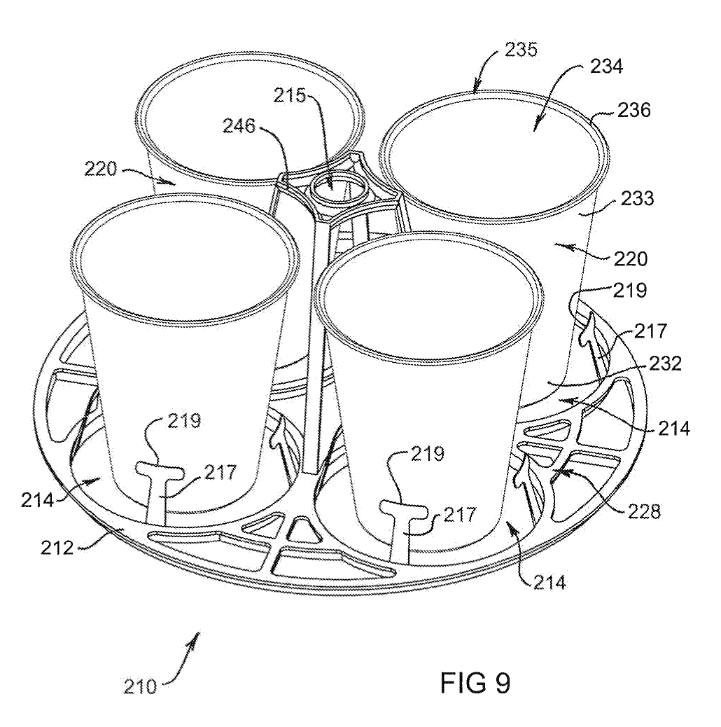

Again, the illustrated carrier 210 is configured to carry at maximum four beverage receptacles 220. In this respect, the carrier 210 includes a planar support structure 212 which includes four openings 214 through which a beverage container, like for example the plastic cups 220 (shown in FIG. 9) can be received. Again, each of the four openings 214 is evenly spaced around a common geometric central axis X-X and extends through the support structure 212. Again, as best seen in FIG. 8, the support structure 212 is formed of an integrally moulded framework of cross-members. A handle 215 having a similar frustoconical configuration as the embodiment of the carrier 210 shown in FIGS. 1 to 4 is also provided. The handle 215 extends perpendicularly from the support structure 212 and is formed from a framework of struts 248 and upper hub 246.

Unlike the carrier 10 shown in FIGS. 1 to 4, these openings 214 include four axially extending fingers 217 spaced substantially evenly around the edge of each opening 214. Each of the fingers 217 comprise an upstanding flexible T-shaped body which is intended to cooperatively engage with a portion of the wall 233 and/or annular bead 236 of a beverage container such as plastic cup 220 inserted into the opening 214. However, the fingers 217 could comprise any suitable shape such as a rectangle, arch or similar. Each of the fingers 217 extend away from the edge of the opening 214 at an angle inwardly towards the center of the opening 214. The angle generally is acute, ranging between 5 to 30 degrees, preferably no more than 10 degrees relative to center axis of the opening. This angle allows the fingers to engage with a plastic cup 220 having a variety of diameters. As shown in FIG. 9, most plastic cups 220 have diameter that tapers from a maximum diameter at the opening 234 and/or rim 235 of the cup 220 to a minimum diameter at the base 232 of the cup 220. The angle and flexibility of each finger 217 is designed to allow the carrier 220 to carry a variety of cup sizes within the openings 217. In this respect, the fingers are able to flex outwardly away from the center of the opening 214 to fit cups 220 of various sizes. For example, the carrier 210 can accommodate cups having a difference in diameter of between 10 to 15%. In one embodiment, this would enable the carrier to accommodate cups which fit the volume of between 425 to 500 mL of liquid. Of course, depending on the diameter of the various cups, this difference in volume can be more substantial.

As shown in FIG. 9, each opening 214 is configured to receive a beverage container 220 having a generally circular cross-section. A plastic cup 220 can be supported in the opening 214 of the carrier 220 through the cooperative engagement of an upper edge 219 of each of the fingers 217 of an opening 214 and a portion of the wall 233 and/or annular bead 236 of the cup 220. In some cases, the cup 220 can be wedged between the four fingers 217 in the opening 214 to be supported at four annularly spaced apart sections of the wall 233 away from the annular bead 236. In most cases this will be at a point between 5 to 30 mm axially away from the annular bead 236 on the wall 233. In other embodiments, the upper edge 219 of each of the fingers 217 engages with the upper edge 219 of each of the fingers 217 to support the cup 220 within the relevant opening 214. In some cups 220, the annular bead 36 includes an undercut section forming a groove (not shown) under the annular bead 36. In some cases, the upper edge 219 of each of the fingers 217 can be configured to seat within this groove to support the cup 220 within the relevant opening 214.

No finger recesses are required to assist in the removal of the cups 220 in this embodiment due to the provision of fingers 217, which seat the rim 235 of the cup 220 proud of the upper surface of the support structure 212 allowing a user to easily grip the side of the cup 220.

The carriers 210 can also be nested together with a plurality of cups 220 held in each of the openings 214 to assist in the bulk transport of the carriers 210 and beverage cups 220 that fit within the carriers 210.

Again, the carrier 210 can be used as an advertising arrangement 68 through the inclusion of a cardboard advertising sheet 70 (similar to that shown in FIG. 4) supported on the support surface 228 of the support structure 212 and a cardboard top promotion disc 42 (similar to that shown in FIG. 4) which can be inserted into disc recess 258 in the upper hub 246 of the handle 215.

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1. A carrier for carrying one or more beverage containers of the kind having a base and a wall extending from the base, the base and wall defining an interior beverage containing space, each beverage container further including an opening opposite the base which is circumscribed by a rim and a protrusion extending laterally relative to the wall near to or at the rim, the carrier including:
a support body including at least two openings, each opening configured to receive and releasably support a beverage container therein through the cooperative engagement of a surface associated with an edge of the opening and a portion of the wall and/or protrusion of the beverage container; and
a handle substantially perpendicularly extending from and generally around the geometric center of the support body, the handle being generally centrally located with respect to each of the at least two openings, the handle allowing a user to balance and carry one or more beverage containers received in the openings about the geometric center of the support body.

2. A carrier according to claim 1, wherein, in use, a beverage container is received within at least one of the openings and is releasably supported therein through the cooperative engagement of a surface associated with an edge of the opening and the protrusion of the beverage container.

3. A carrier according to claim 1 or 2, wherein each opening includes at least two axially extending fingers spaced apart around the edge of each opening, a beverage container being releasably supported therein through the cooperative engagement of an edge of each of the fingers a portion of the wall and/or protrusion of the beverage container.

4. A carrier according to claim 3, wherein the axially extending fingers extend away from the edge of the opening at an angle towards the center of the opening.

5. (canceled)

6. A carrier according to claim 3, in which the carrier is for carrying one or more beverage containers of the kind in which the protrusion includes a substantially annular groove proximate an interface between the wall and the protrusion, and wherein, in use, a beverage container is releasably supported within at least one opening of the carrier through the cooperative engagement of an edge of each of the fingers within the annular groove of the protrusion of the beverage container.

7. A carrier according to claim 1, wherein the support body includes a generally planar support surface through which each of the openings extend, and wherein the handle extends generally perpendicular to the support surface.

8. A carrier according to claim 7, wherein the handle includes a finger grip portion, the finger grip portion being spaced from the support surface and generally centrally located with respect to each of the openings.

9. A carrier according to claim 1, wherein the handle is formed from one or more elongate struts which extend away from the support surface.

10. A carrier according to claim 1, wherein the handle is configured to nest with at least an upper portion of the handle of a second carrier thereby allowing respective carriers to be stacked on top of each other.

11. A carrier according to claim 10, wherein the handle has a frustoconical configuration and is substantially hollow.

12. A carrier according to claim 1, wherein the handle includes a recess in which a promotion disc can be releasably secured.

13. A carrier according to claim 7, wherein the support surface includes an advertising substrate.

14. A carrier according to claim 13, wherein the advertising substrate is integrally formed with the support surface.

15. A carrier according to claim 1, further including an advertising substrate which can be releasably supported on the support body, the advertising substrate having one or more openings for the handle and the at least one opening of the support body.

16. (canceled)

17. A carrier according to claim 15, wherein the advertising substrate comprises a sheet having a printed surface configured to be seated on the support body.

18. A carrier according to claim 15, wherein one or more openings of the advertising substrate include an edge configured to engage a portion of the support body or handle to releasably retain the substrate in position relative to the support body and the at least one opening of the support body.

19. A carrier according to claim 18, wherein the support body includes one or more ridges configured to engage an edge of the advertising substrate and locate the advertising substrate in position relative to the support body and the at least one opening of the support body.

20. (canceled)

21. An advertising arrangement including:
a carrier for carrying one or more beverage containers of the kind having a base and a wall extending from the base, the base and wall defining an interior beverage containing space, each beverage container further including an opening opposite the base which is circumscribed by a rim and a protrusion extending laterally relative to the wall near to or at the rim, the carrier including a support body including at least one opening, and a handle extending from the support body; and
an advertising substrate which can be releasably supported on the support body, the advertising substrate having cooperating openings for the handle and the openings of the support body,
wherein, in use, a beverage container is received within at least one of the openings of the support body and is releasably supported therein through the cooperative engagement of a surface associated with an edge of the opening and/or the advertising substrate supported thereon and a portion of the wall or protrusion of the beverage container.

22. An advertising arrangement according to claim 21, wherein the advertising substrate comprises a sheet having a printed surface configured to be seated on the support surface of the support body of the carrier.

23. (canceled)

24. An advertising arrangement according to claim 21 including a carrier for carrying beverage containers according to claim 1.
